(19) United States
(12) Patent Application Publication
(10) Pub. No.: US 2015/0107733 A1
(43) Pub. Date: Apr. 23, 2015

(54) VEGETABLE OIL BASED RUBBER CEMENT AND TIRE WITH FABRICATED TREAD

(71) Applicant: The Goodyear Tire & Rubber Company, Akron, OH (US)

(72) Inventor: Paul Harry Sandstrom, Cuyahoga Falls, OH (US)

(73) Assignee: The Goodyear Tire & Rubber Company, Akron, OH (US)

(21) Appl. No.: 14/060,870

(22) Filed: Oct. 23, 2013

(51) Int. Cl. C09J 109/06; B60C 1/00; B29D 30/58; C09J 109/00; C09J 11/06

(52) U.S. Cl. CPC C09J 109/06; C09J 109/00; C09J 11/06; B29D 30/58; B60C 1/0016; B29K 2009/00
USPC 152/209.1; 523/156; 156/128.1

(57) ABSTRACT

The invention relates to a vegetable oil based rubber cement and tire with fabricated tread. In one embodiment, the invention relates to a tire with a rubber tread with a splice containing a vegetable oil based rubber cement. In one embodiment the tread rubber contains precipitated silica reinforcement. In one embodiment, the vegetable oil is comprised of soybean oil. In one embodiment the vegetable oil is provided in a vegetable oil extended elastomer. In one embodiment, the vegetable oil is provided as an additive to the rubber based adhesive.

### FIELD OF THE INVENTION

This invention relates to a tire with circumferential tread of a rubber which contains reinforcing filler comprised of precipitated silica. The circumferential rubber tread is configured as a rubber strip having its ends joined together to form a splice with a vegetable oil based rubber cement there between. The vegetable oil based rubber cement may contain a silica coupling agent. The vegetable oil may comprise soybean oil. The invention further relates to a method of preparing a tire with such circumferential spliced tread.

### BACKGROUND OF THE INVENTION

Rubber tires are often prepared in a manufacturing process which comprises applying an uncured rubber tread strip circumferentially around a tire carcass with ends of the rubber strip meeting and joined together to form a splice. In one embodiment, the ends of the uncured rubber tread strip may be skived, or cut at an angle, to permit the ends of the uncured rubber strip to overlay (overlap) each other to form the splice. An adhesive, often referred to as a cement, may be applied to at least one end of the uncured tread rubber strip to secure the splice for the tire building and shaping processes. Such tread fabrication utilizing a splice to join the ends of an uncured tread rubber strip with an adhesive, sometimes referred to as a cement, between its ends at the splice is well known to those having skill in such art.

Historically, carriers for such cements have heretofore been, for example, volatile organic solvents, petroleum-based oils or water. Each of such carriers presents advantages and disadvantages.

Significantly, high contents of precipitated silica reinforcement in the tread rubber typically “dries the uncured rubber” in a sense of adversely reducing its tack.

Here, it is desired to provide and use a cement to promote uncured rubber surface tack for tire building and shaping purposes (e.g. in a sense of holding the tread splice together).It may also be desired to promote cured adhesion at the tread splice between ends of the cured rubber tread.

In one aspect, for high performance intended tire treads, the uncured elastomers may have a high viscosity (e.g. elastomers with high Mooney viscosities) which renders them difficult to process in rubber processing equipment. For such high viscosity elastomers, at least one of petroleum based oil and vegetable oil may be blended with the elastomer during its manufacture. Such elastomers are often referred to as being oil extended or as oil extended elastomers.

As indicated, it is desirable for the cement to provide building tack for the uncured rubber strip to secure the splice during the building and molding of the tire and may be desired to provide improved cured adhesion to secure the splice for the cured rubber tread of the cured rubber tire. For example, see U.S. Pat. No. 8,143,338.

Further examples of various cements for joining tread splices may be referred to in, for example and not intended to be limiting, U.S. Pat. Nos. 3,335,041; 3,421,565; 3,342,238; 3,514,423; 4,463,120, 4,539,365, 5,503,940 and 5,951,797.

As indicated, historically, various cements for tire tread splices have been organic solvent based, petroleum oil based and water based cements with a primary purpose of providing building tack to secure the uncured tread splice during the building and shaping of the tire. For example, such cement may have comprised a base rubber, hydrocarbon oil, carbon black, tackifier resin and sometimes a curative.

However, as indicated, tread rubber compositions containing a significant content of precipitated silica reinforcement typically adversely reduces building tack for the uncured rubber composition. Therefore, alternate methods for providing building tack are sought for the uncured tread rubber splice, which may also include providing cured adhesion for the cured tread rubber splice.

Vegetable oil (a triglyceride oil), such as for example soybean oil based cement is proposed, instead of the aforesaid petroleum hydrocarbon, organic solvent and water based cements.

Further, a vegetable oil based cement containing a silica coupling agent for the precipitated silica in the tread rubber composition is proposed to promote cured adhesion of the tread splice.

It is important to appreciate that vegetable oils, including soybean oil, differ significantly from petroleum based oils, particularly in a sense that vegetable oils are triglycerides which contain a significant degree of unsaturation and are clearly not a linear or an aromatic petroleum based oil.

The vegetable oils (triglyceride oils) include, for example, soybean oil, sunflower oil and canola oil which are in the form of esters containing a significant degree of unsaturation.

For informational purposes to illustrate the aforesaid of relative saturated, mono unsaturated and polyunsaturated contents of various vegetable oils, the following Table A is provided.

TABLE A

| | Percent | Percent | Percent |
|---|---|---|---|
| Vegetable Oil | Saturated | Mono Unsaturated | Poly Unsaturated |
| Soybean | 16 | 23 | 58 |
| Sunflower | 10 | 45 | 40 |
| Canola (Rapeseed) | 7 | 63 | 28 |
| Corn | 13 | 28 | 55 |
| Coconut | 87 | 6 | 2 |
| Cottonseed | 26 | 18 | 52 |
| Olive | 14 | 73 | 11 |
| Palm | 49 | 37 | 9 |
| Peanut | 17 | 46 | 32 |
| Safflower | 10 | 45 | 40 |

It can readily be seen that such vegetable oils, such as for example, soybean oil, contain a significant unsaturation content which is not present in petroleum based rubber processing oils.

Therefore, substituting a vegetable oil, for example soybean oil, for petroleum based oil in an adhesive cement for an uncured tread strip splice is a significant change and particularly when used as a cement for tread strip rubber composition containing high concentrations of precipitated silica reinforcing filler.

A significant challenge exists for providing building tack for an uncured tread rubber splice where its rubber composition contains a high content of precipitated silica, particularly where the precipitated silica content may significantly exceed the content of rubber reinforcing carbon black and where the precipitated silica concentration may exceed the concentration of the elastomer itself in the rubber composition.

The challenge may particularly exist where the precipitated silica is a hydrophobated precipitated silica, namely a pre-hydrophobated silica.

It is to be appreciated that precipitated silica (an amorphous synthetic silica) is hydrophilic in nature and thereby challenging to efficiently blend with and disperse within diene-based elastomers unless it is made more hydrophobic in nature, a subject understood to be well known to those having skill in such art. Such hydrophilic precipitated silica may, for example, be hydrophobated in situ within the rubber composition or may be pre-hydrophobated prior to its addition to a rubber composition. For example, see U.S. Pat. Nos. 4,474,908, 5,780,538, 6,127,468 and 6,573,324

The precipitated silica may be hydrophobated for example, with one or more hydrophobation promoting compounds which are reactive with hydroxyl groups (e.g. silanol groups) contained on the precipitated silica which may be comprised of, for example one or more of alkoxysilane, alkylsilane, halogenated alkylsilane, and silica coupling agents such as, for example, bis(3-trialkoxysilylalkyl) polysulfide containing an average in a range from about 2 to about 4 connecting sulfur atoms in their polysulfidic bridges (e.g. comprised of bis(3-tri ethoxysilylpropyl) polysulfide, or an organoalkoxymercaptosilane.

Such hydrophobation promoting compounds rely, at least in part, upon reaction of its silane or siloxane moiety with hydroxyl groups (e.g. silanol groups) on the precipitated silica. For such reaction, it is understood that not all of the hydroxyl groups of the precipitated silica become chemically interacted with such compounds and that therefore a portion of the hydroxyl groups on the precipitated silica remain as available hydroxyl groups for further chemical reaction(s).

In one embodiment, it is desired to undertake providing building tack to the ends of such uncured rubber tread strip which contains a high content of precipitated silica, where the precipitated silica may be a hydrophobated precipitated silica, such as, for example, an uncured tread rubber strip comprised of a rubber composition having a precipitated silica, or hydrophobated precipitated silica, content of at least about 50 parts by weight, alternately at least about 75 parts by weight, alternately at least about 105 parts by weight and alternately at least about 175 parts by weight, per 100 parts by weight elastomer(s) (e.g. at least 50, 70, 105 and 175 phr of the silica).

Where the cement also contains a silica coupling agent, it is desired for the cement to interact with the precipitated silica, which may be a hydrophobated precipitated silica, to both provide building tack for the uncured rubber splice as well to provide adhesion for the cured rubber splice.

While this invention relates to promoting both uncured rubber building tack and cured rubber adhesion of ends of a precipitated silica containing rubber tread strip at a tread splice with the cement of this invention for the building of a tire, it is to be appreciated that building tack and cured adhesion for other precipitated silica containing rubber components may be promoted by application of the cement of this invention to a surface of such components.

In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art.

### SUMMARY AND PRACTICE OF THE INVENTION

This invention relates to a cement for providing building tack to spliced ends of a precipitated silica containing tire tread rubber strip wherein the cement is comprised of vegetable oil (e.g. soybean oil), conjugated diene based elastomer, sulfur curative and optionally at least one of hydrocarbon resin and silica coupling agent.

This invention further relates to a tire which contains a circumferential tread comprised of the tread rubber strip with its ends spliced together to form a splice with the cement between the ends of the tread rubber ends at the splice.

The invention further relates to a method of preparing a tire with a circumferential tread comprised of a spliced rubber strip with a cement applied to ends of the rubber strip at the splice.

According to this invention, a cement is provided for promoting building tack for an uncured rubber composition of a tread rubber strip containing at least one conjugated diene based elastomer and precipitated silica reinforcement, wherein said cement is comprised of vegetable oil, at least one conjugated diene based elastomer and sulfur curative,
wherein said diene-based elastomer for said cement is comprised of at least one of polymers of at least one of isoprene and 1,3-butadiene and copolymer of styrene with at least one of isoprene and 1,3-butadiene;
wherein said sulfur curative is comprised of sulfur and at least one sulfur cure accelerator, and
wherein said vegetable oil is comprised of at least one of soybean oil, sunflower oil and canola oil.

Desirably, the vegetable oil is comprised of soybean oil.

Optionally, and most desirably, the cement contains a silica coupling agent having a moiety reactive with hydroxyl groups on said precipitated silica and another different moiety interactive with said diene-based elastomer(s) contained in said tread rubber strip.

In one embodiment, said precipitated silica is comprised of a precipitated silica hydrophobated with (pre-treated with):
(A) at least one silica coupling agent comprised of:
   (1) bis (3-trialkoxysilylalkyl) polysulfide containing an average from about 2 to about 4 connecting sulfur atoms in its polysulfidic bridge (e.g. comprised of bis(3-triethoxysilylpropyl) polysulfide), or
   (2) alkoxyorganomercaptosilane, and optionally;
(B) at least one alkoxysilane, and
(C) combination of said silica coupling agent and alkoxysilane.

Optionally, the cement contains at least one hydrocarbon resin (e.g. from about 0.5 to about 30 parts by weight resin per 100 parts by weight conjugated diene-based elastomer(s)). Representative of such resin is, for example, at least one of coumarone-indene resin, petroleum derived resin, terpene resin and rosin acid and rosin acid derivatives.

Optionally, the cement contains reinforcing filler comprised of rubber reinforcing carbon back (e.g. from about 5 to about 100 parts rubber reinforcing carbon black per 100 parts by weight conjugated based elastomer(s) in said cement).

Desirably, the cement is used without containing precipitated silica, although, where appropriate or desired, it may contain from about 5 to about 30 parts by weight precipitated silica per 100 parts by weight elastomer (phr).

Optionally, the cement contains up to 30, alternately up to 10, percent by weight petroleum oil based on the total of said vegetable oil and petroleum oil.

In one embodiment, the tread rubber strip contains from about 50 to about 200, alternately from about 75 to about 150, alternately from about 105 to about 175 and alternately from about 175 to about 200, parts of precipitated silica per 100 parts of diene-based elastomer(s) in said tread rubber strip.

Therefore, it is appreciated that, where the content of precipitated silica in said tread rubber strip is in a range of from about 105 to about 175 parts by weight per 100 parts by weight diene-based elastomer(s), the content of precipitated silica in said tread rubber strip may be greater than the content of diene-based elastomer in the rubber composition.

In one embodiment, said cement and uncured rubber strip are co-cured together to form a cured rubber splice.

In further accordance with this invention, a tire is provided having a circumferential rubber tread comprised of an uncured rubber strip having its ends spliced together to form a splice with a said cement provided as a layer between its ends in said splice, where the uncured rubber strip is a rubber composition comprised of at least one conjugated diene-based elastomer, precipitated silica and sulfur curative.

In one embodiment, the tire is provided with the cement and said tread rubber strip sulfur co-cured together to form a cured rubber tread splice.

In additional accordance with this invention a method of preparing a tire comprises:
(A) Building a rubber tire having with a rubber tread comprised of an uncured tread rubber strip of a rubber composition comprised of at least one conjugated diene-based elastomer, precipitated silica and sulfur curative,
(B) Splicing the ends of said circumferential tread rubber strip together with said cement applied to at least one end of said tread rubber strip and thereby contained between the ends of said tread rubber strip at the splice, and
(C) Sulfur co-curing said uncured rubber strip and cement together.
   In one embodiment, said cement contains said silica coupling agent and optionally at least one of said hydrocarbon resin and said rubber reinforcing carbon black.

In additional accordance with this invention, a tire is provided as being prepared by such method.

In one embodiment of this invention, said precipitated silica for said tread rubber strip is a precipitated silica pre-treated with said silica coupler prior to addition to said rubber composition,

In one aspect of the invention, the rubber reinforcing carbon black, and optional hydrocarbon resin is provided in said cement to promote said building tack and increasing green strength of the cement and ultimately promoting sulfur cured strength of the cement at the tread strip splice in the cured tire.

While the vegetable oil is the carrier for ingredients of the cement, it can comprise, if desired and appropriate, up to about 30 weight percent petroleum based hydrocarbon oil, although it is usually desired that the vegetable oil is used without the presence of a petroleum based hydrocarbon oil. Therefore, it may desired for the cement to be substantially free of petroleum based oil in the sense of being exclusive of, or containing less than 10 weight percent petroleum oil, based on the oil itself.

In one embodiment, the conjugated diene-based elastomer in the vegetable oil based cement is comprised of at least one of cis, 1,4-polyisoprene, cis 1,4-polybutadiene, and styrene/butadiene copolymers.

In one embodiment, said vegetable oil is comprised of at least one of soybean, sunflower, canola, corn, coconut, cottonseed, olive, palm and peanut oil.

As indicated, in one embodiment said vegetable oil is comprised of soybean oil.

As indicated, in one embodiment, the cement contains from about 0.5 to about 30 phr of the hydrocarbon resin comprised of at least one of coumarone-indene resin, petroleum derived resin, terpene resin and rosin acid and derivatives and mixtures thereof.

Coumarone-indene resins are commercially available in many forms with melting points ranging from 10° C. to 160° C. (as measured by the ball-and-ring method). Preferably, the melting point ranges from 30° C. to 100° C. Coumarone-indene resins are well known.

Hydrocarbon resins are, in general, petroleum resins commercially available with softening points ranging from 10° C. to 120° C. Desirably, the softening point ranges from 30° C. to 100° C. Suitable petroleum resins include both aromatic and non-aromatic resins. Several types of petroleum resins are available. Some resins have a low degree of unsaturation and high aromatic content, whereas some are highly unsaturated and yet some contain no aromatic structure at all. Differences in the hydrocarbon resins are largely due to the olefins in the feedstock from which the resins are derived. Conventional derivatives in such resins include dicyclopentadiene, cyclopentadiene, their dimers and diolefins such as isoprene and piperylene.

Terpene resins are produced, for example, by polymerizing beta pinene which may be contained in mineral spirits. The resin may be provided in a variety of melting points ranging, for example, from about 10° C. to 135° C. The terpene resin may also, for example, be a copolymer of beta pinene and diclopentadiene.

Phenol/acetylene resins may be used. Phenol/acetylene resins may be derived, for example, by the addition of acetylene to an alkyl phenol such as for example butyl phenol, in the presence of, for example, zinc naphthlate.

Historically, rosin acid resin, which might sometimes be referred to as “rosin”, is a solid resinous material (at 23° C.) which contains a high concentration of carboxylic acid groups which occurs naturally in pine trees. There are three major exemplary sources of the rosin acid which might be referred to as gum, wood and tall oil rosin

Gum rosin acid, which might be referred to as “rosin”, is typically from the oleoresin extrudate of the living pine tree.

Wood rosin acid, which might be referred to as “wood rosin” or “rosin”, is typically from the oleoresin contained in the aged pine tree stumps.

Tall oil rosin acid, which might be referred to as “rosin”, is typically from the waste liquor recovered as a by-product in the paper production industry. For example, wood rosin may be obtained from aged pine tree stumps. In such practice, a pine tree stump may be allowed to remain in the ground for a number of years so that its bark and sapwood may decay and slough off to leave the heartwood rich in rosin acid, which might sometimes be referred to as “wood rosin”. Historically, rosin acids derived from both oleoresin and aged pine tree stump wood are typically composed of, for example, about 90 percent rosin acids and, for example, about 10 percent nonacidic components.

Representative of various wood rosin acids are, for example, rosin acids referred to as abietic, levopimaric, neoabietic, palustric, dehydroabietic, dihydroabietic, tetrahydroabietic, pimaric, isopimaric, elliotinoic and sandaracopimaric.

A significant aspect of the invention is use of a vegetable oil (e.g. soybean oil) in the cement.

The invention is also directed to a tire made by the foregoing method.

The diene based elastomer(s) for the tread rubber strip, may be comprised of at least one polymer of at least one of isoprene and 1,3-butadiene and styrene with at least one of isoprene and 1,3-butadiene.

As indicated, representative of such elastomers is, for example, cis 1,4-polyisoprene, cis 1,4-polybutadiene, styrene/butadiene, isoprene/ butadiene and isoprene/butadiene/styrene polymers or elastomers.

In one embodiment, an elastomer (e.g. a styrene/butadiene rubber) may be a tin or silicon coupled elastomer.

In one embodiment, an elastomer may be a functionalized elastomer (e.g. a styrene/butadiene rubber) containing, for example, at least one functional group comprised of at least one of amine, siloxy, carboxyl and hydroxyl groups, particularly functional groups. Such functional groups may be reactive with, for example, hydroxyl groups on a precipitated silica, particularly on said hydrophobated precipitated silica.

In one embodiment, an elastomer may be a tin or silicon coupled elastomer (e.g. a styrene/butadiene rubber) containing at least one functional group comprised of, for example, amine, siloxy, carboxyl and hydroxyl groups. Such functional groups may be reactive with hydroxyl groups of a precipitated silica, particularly said hydrophobated precipitated silica.

The commonly employed precipitated silica reinforcement may be, for example, a precipitated silica formed by the acidification of a soluble silicate, e.g., sodium silicate.

Such conventional precipitated silicas might be characterized, for example, by having a BET surface area, as measured using nitrogen gas. In one embodiment, the BET surface area may be in the range of about 40 to about 600 square meters per gram. In another embodiment, the BET surface area may be, for example, in a range of about 80 to about 300 square meters per gram. The BET method of measuring surface area is well known by those having skill such art.

Various commercially available silicas may be used, such as, and without limitation, silicas commercially available from PPG Industries under the Hi-Sil trademark with designations 210, 243, etc.; silicas available from Rhodia, with, for example, designations of Z1165MP and Z165GR and silicas available from Evonik with, for example, designations VN2 and VN3, etc.

Commonly employed carbon blacks can be used in the cement composition in an amount ranging from 30 to 70 phr. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

The vegetable oil (e.g. soybean oil) based adhesive (cement) may be applied to the surface of the ends of the uncured tread rubber strip using any of the various application methods as are known in the art, including but not limited to spraying, brushing, dipping, and wiping.

While in accordance with the patent statutes the best mode and preferred embodiment has been set forth, the scope of the invention is not limited thereto, but rather by the scope of the attached claims.

What is claimed is:

1. Cement for promoting building tack for an uncured rubber composition of a tread rubber strip containing at least one conjugated diene based elastomer and precipitated silica reinforcement, wherein said cement is comprised of vegetable oil, at least one conjugated diene based elastomer and sulfur curative,
wherein said diene-based elastomer for said cement is comprised of at least one of polymers of at least one of isoprene and 1,3-butadiene and copolymer of styrene with at least one of isoprene and 1,3-butadiene;
wherein said sulfur curative is comprised of sulfur and at least one sulfur cure accelerator, and
wherein said vegetable oil is comprised of at least one of soybean oil, sunflower oil and canola oil.

2. The cement of claim 1 wherein said vegetable oil is comprised of soybean oil.

3. The cement of claim 1 wherein said cement contains a silica coupling agent having a moiety reactive with hydroxyl groups on said precipitated silica in said tread rubber strip.

4. The cement of claim 1 wherein said cement contains at least one hydrocarbon resin.

5. The cement of claim 3 wherein said cement contains a silica coupling agent having a moiety reactive with hydroxyl groups on said precipitated silica in said tread rubber strip and another different moiety interactive with said conjugated diene-based elastomer(s) in said tread rubber strip.

6. The cement of claim 1 wherein said cement further contains reinforcing filler comprised of rubber reinforcing carbon black.

7. The cement of claim 1 which contains up to 30 weight percent petroleum oil based on the total of vegetable oil and petroleum oil.

8. A tire having a circumferential rubber tread comprised of an uncured rubber strip having its ends spliced together to form a splice with a cement layer between its ends in said splice comprised of the cement of claim 1, wherein the rubber composition of said rubber strip is comprised of at least one conjugated diene-based elastomer which contains precipitated silica and sulfur curative comprised of sulfur and at least one sulfur vulcanization accelerator.

9. The tire of claim 8 wherein the rubber composition of said tread strip contains from about 50 to about 200 parts by weight of precipitated silica per 100 parts by weight conjugated diene based elastomer in said tread strip.

10. The tire of claim 8 wherein said cement and said tread rubber strip are sulfur co-cured together to form a cured rubber splice.

11. The tire of claim 9 wherein said cement and said tread rubber strip are sulfur co-cured together to form a cured rubber splice.

12. The tire of claim 8 wherein said cement is comprised of the cement of claim 3

13. The tire of claim 11 wherein said cement is comprised of the cement of claim 2.

14. The tire of claim 11 wherein said cement is comprised of the cement of claim 3.

15. The tire of claim 11 wherein said cement is comprised of the cement of claim 4 wherein said hydrocarbon resin is comprised of at least one of coumarone-indene resin, petroleum derived resin, terpene resin and rosin acid and rosin acid derivatives.

16. The tire of claim 11 wherein said cement is comprised of the cement of claim 5 wherein cement contains from about 5 to about 100 parts by weight of rubber reinforcing carbon black per 100 parts by weight of said diene-based elastomer in said cement

17. The tire of claim 11 wherein said cement is comprised of the cement of claim 6.

18. The tire of claim 11 wherein said cement is comprised of the cement of claim 7.

19. A method of preparing a tire which comprises:
(A) Building a rubber tire with a rubber tread comprised of an uncured tread rubber strip of a rubber composition comprised of at least one conjugated diene-based elastomer, precipitated silica and sulfur curative,
(B) Splicing the ends of said circumferential tread rubber strip together with a cement comprised of the cement of claim 1 applied to at least one end of said tread rubber strip and thereby contained between the ends of said tread rubber strip at the splice, and
(C) sulfur co-curing said uncured rubber strip and cement together.

20. The method of claim 19 wherein said cement contains a silica coupling agent and at least one of hydrocarbon resin and rubber reinforcing carbon black.
